(19) United States
(12) Patent Application Publication
(10) Pub. No.: US 2016/0153652 A1
(43) Pub. Date: Jun. 2, 2016

(54) WEARABLE ARTICLES WITH LIGHTING FEATURES

(71) Applicant: American Mills Intl. LLC, Minneapolis, MN (US)

(72) Inventor: Brad Peterson, Minneapolis, MN (US)

(73) Assignee: American Mills Intl. LLC, Minneapolis, MN (US)

(21) Appl. No.: 14/957,419

(22) Filed: Dec. 2, 2015

Related U.S. Application Data
(60) Provisional application No. 62/086,427, filed on Dec. 2, 2014.

(51) Int. Cl. F21V 33/00; F21L 4/00; A42B 1/24; F21V 23/04

(52) U.S. Cl. CPC F21V 33/0008; F21V 23/0414; F21L 4/00; A42B 1/242; F21Y 2103/006

(57) ABSTRACT

A wearable article is described. The wearable article may include a fabric piece, an electroluminescent (EL), and a switch. The EL wire may include a conductor and a light emitting phosphor in contact with the conductor and configured to enclose the conductor and to emit light in response to the conductor receiving power. The EL wire may also include an insulator configured to enclose the light emitting phosphor. The insulator may include a structure configured to attach to the fabric piece. The switch may be configured to control power supplied to the conductor such that the switch controls an operation mode of the EL wire.

### FIELD

Some embodiments described in the present disclosure generally relate to wearable articles with lighting features.

### BACKGROUND

Under some circumstances, a person may be hard to find or see in low-light conditions. Such low visibility may lead to dangerous or frustrating situations for the person or those who may be looking for the person.

The subject matter claimed herein is not limited to embodiments that solve any disadvantages or that operate only in environments such as those described above. Rather, this background is only provided to illustrate one exemplary technology area where some embodiments described herein may be practiced. Further, unless otherwise indicated, the materials described in the background section are not prior art to the claims in the present application and are not admitted to be prior art by inclusion in this section.

### BRIEF SUMMARY OF SOME EXAMPLE EMBODIMENTS

According to an aspect of an embodiment, a wearable article is described. A wearable article is described. The wearable article may include a fabric piece, an electroluminescent (EL), and a switch. The EL wire may include a conductor and a light emitting phosphor in contact with the conductor and configured to enclose the conductor and to emit light in response to the conductor receiving power. The EL wire may also include an insulator configured to enclose the light emitting phosphor. The insulator may include a structure configured to attach to the fabric piece. The switch may be configured to control power supplied to the conductor such that the switch controls an operation mode of the EL wire.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram that illustrates an example wearable article with a lighting feature;

FIG. 2 is a block diagram that illustrates an example lighting system;

FIG. 3 is a graphic representation that illustrates an example wearable article with a lighting feature;

FIG. 4 is a graphic representation that illustrates an example electroluminescent (EL) wire attached to fabric pieces of a wearable article; and

FIG. 5 is a flowchart of an example method of producing a wearable article. c.)

### DETAILED DESCRIPTION OF SOME EXAMPLE EMBODIMENTS

Embodiments described herein generally relate to wearable articles that includes lighting features.

Some embodiments described herein may include a wearable article equipped with a lighting system. The lighting system may provide a unique lighting feature to the wearable article so that attention may be drawn to the wearable article and a value of the wearable article may be increased as a promotion and/or advertising item. The wearable article with the lighting feature may be more visible in a low light environment than non-illuminated wearable articles and may be used for safety and/or advertising purposes.

The lighting system may include a power supply (e.g., a battery), a switch, an electroluminescent EL wire, and any other suitable elements. The EL wire may be electrically coupled to the power supply. The switch may be configured to control the power supply from the power supply to the EL wire and to control an operation mode of the EL wire. For example, the switch may turn the power supply on and may enable the EL wire to switch between a continuous on mode, a flashing on and off mode, and a gradual on and off mode.

Reference will now be made to the drawings to describe various aspects of some example embodiments of the present disclosure. The drawings are diagrammatic and schematic representations of such example embodiments, and are not limiting of the present disclosure, nor are they necessarily drawn to scale.

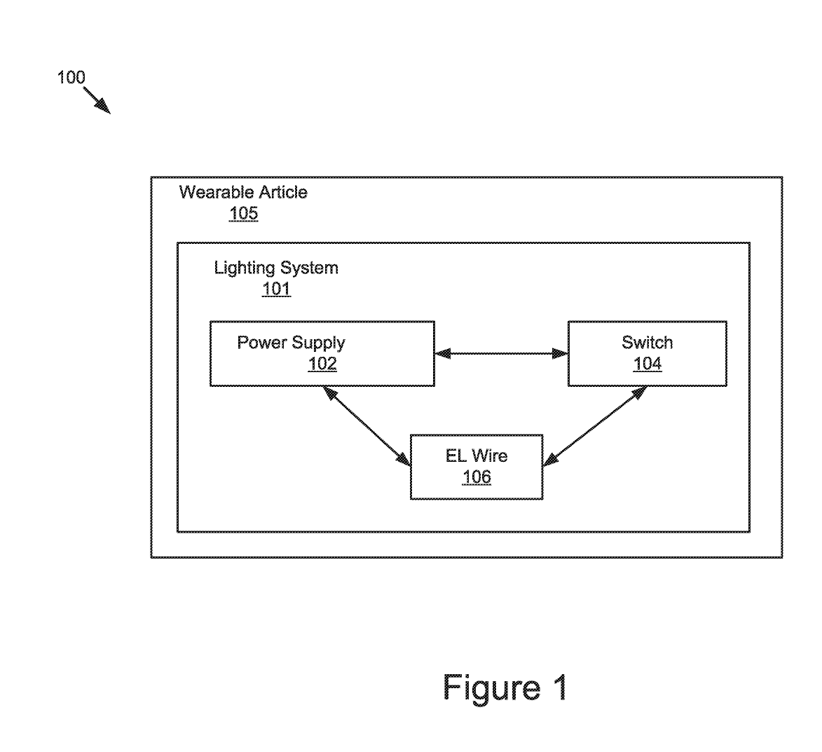

FIG. 1 is a block diagram 100 that illustrates a block diagram of an example wearable article 105, arranged in accordance with at least some embodiments described in the present disclosure. Examples of the wearable article 105 may include, but are not limited to, a headwear article (e.g., a cap, a lid, a helmet, and any other suitable headwear article), a belt, a wrist band, a piece of jewelry, a costume, a jersey, a garment, and any other types of articles that may be worn or carried by users.

The wearable article 105 may include a lighting system 101 configured to emit light. The lighting system 101 may be installed in, embedded in, and/or attached to the wearable article 105. In some embodiments, the lighting system 101 may include a power supply 102, a switch 104, an EL wire 106, and any other suitable elements. The power supply 102, the switch 104, and the EL wire 106 may be electrically coupled to one another.

The power supply 102 may be configured to supply power to illuminate the EL wire 106. The power supply 102 may include a battery (e.g., a one-time use battery or a rechargeable battery), an energy harvesting device that may harvest ambient energy from a surrounding environment (e.g., a piezoelectric device, a heat harvesting device or a light harvesting device), and/or any other suitable power supply sources.

Configurations of the power supply 102 may vary depending on a dimension of the EL wire 106. For example, the power supply 102 may be configured based on a length and/or a diameter of the EL wire 106. In particular, in some embodiments, power output, electrical storage capacity, etc. of the power supply 102 may be based on a power requirement of the EL wire 106, which may be based on the length and/or the diameter of the EL wire 106.

A location where the power supply 102 may be embedded or installed in the wearable article 105 may be determined based on a construction and/or manufacturing mechanism of the wearable article 105. The location and configuration of the power supply 102 in the wearable article 105 may be such that it may satisfy one or more of the following: easy access for operation and battery changes, attractiveness (e.g., as to not draw away from the value of the wearable article), comfortable and unobtrusive requirements, and/or any other requirements. For example, in some embodiments, the wearable article 105 may include a baseball cap and the power supply 102 may include relatively flat batteries (e.g., batteries used in watches) embedded in a sweat band of the baseball cap.

The switch 104 may be configured to control the power supply from the power supply 102 to the EL wire 106. For example, the switch 104 may be configured to turn the power supply on and/or off. The switch 104 may be further configured to control an operation mode of the EL wire 106. Example operation modes of the EL wire 106 that may be controlled by the switch 104 may include, but are not limited to, a continuous on mode, a flashing on and off mode, a gradual on and off mode, and any other suitable modes. For example, the switch 104 may be turned to different switching positions so that the EL wire 106 may be set in the continuous on mode, the flashing on and off mode, or the gradual on and off mode.

In some embodiments, the switch 104 may include a special-purpose or general-purpose computer (e.g., a processor or processing system) including various computer hardware or software modules, as discussed in greater detail below. Further, one or more operations of the switch 104 may be implemented using computer-readable media (e.g., memory) for carrying or having computer-executable instructions or data structures stored thereon.

A processor or processing system may include any suitable special-purpose or general-purpose computer, computing entity, or processing device including various computer hardware or software modules and may be configured to execute instructions stored on any applicable computer-readable storage media. For example, the processor may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 1B, it is understood that the processor 110 may include any number of processors configured to perform any number of operations individually or collectively. Additionally, one or more of the processors may be present on a different electronic device. In some embodiments, the processor or processing system may interpret and/or execute program instructions and/or process data stored in the memory.

The memory may include computer-readable storage media for carrying or having computer-executable instructions or data structures stored thereon. Such computer-readable storage media may be any available media that may be accessed by a general-purpose or special-purpose computer, such as the processor or processing system. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured for the processor or processing system to cause a system (e.g., the lighting system 101) to perform a certain function or group of functions.

As used herein, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The location and configuration of the switch 104 in the wearable article 105 may be such that it may satisfy one or more of the following: easy access for operation, attractiveness (e.g., as to not draw away from the value of the wearable article), comfortable and unobtrusive requirements, and/or any other requirements. For example, in some embodiments, the wearable article 105 may include a baseball cap and the switch 104 may be integrated within a visor of the baseball cap.

The EL wire 106 may include any suitable electroluminescent wire configured to emit light in response to power supplied by the power supply 102. For example, the EL wire 106 emit light in response to the switch 104 turning on the power supply from the power supply 102. Different colors for the EL wire 106 are possible. For example, the EL wire 106 may emit light with a blue color, a yellow color, a green color, a red color, an orange color, a pink color, a purple color, a white color, and/or another suitable color.

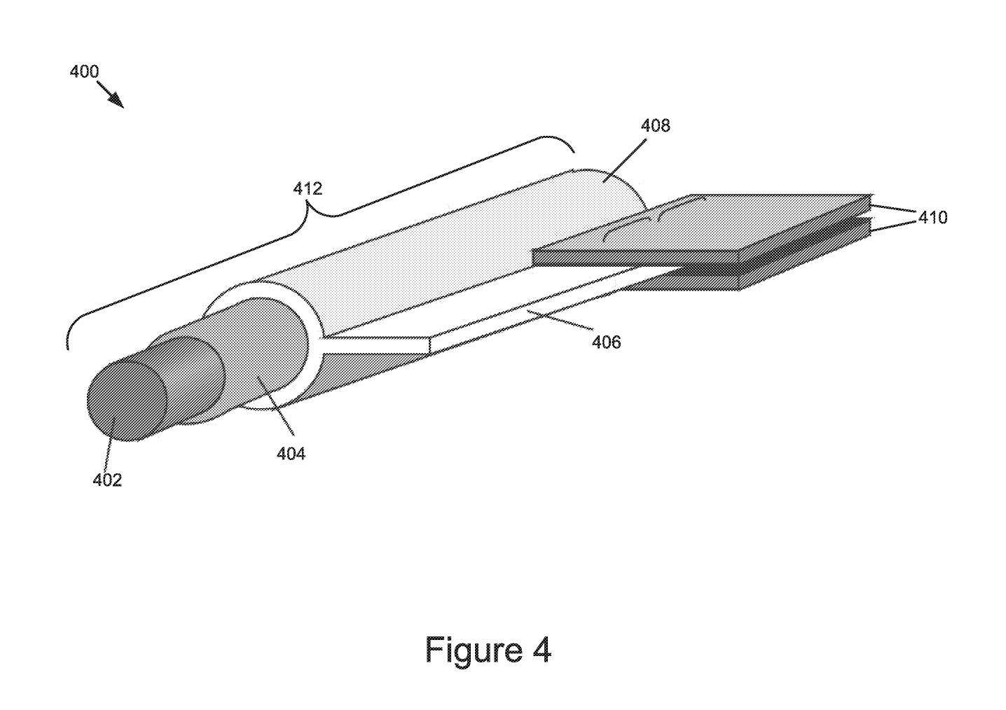

The EL wire 106 may be permanently or removably attached to the wearable article 105. For example, if the wearable article 105 includes a baseball cap, the EL wire 106 may be attached to an edge of a visor of the baseball cap. An example structure of the EL wire 106 is illustrated with reference to FIG. 4. The EL wire 106 may be made of flexible materials such that the EL wire 106 may follow a curvature of the wearable article 105.

Modifications, additions, or omissions may be made to the wearable article 105 without departing from the scope of the present disclosure. For example, the wearable article 105 may include any number of other elements or components not specifically described or mentioned. Further, the locations of the power supply 102, the switch 104, and/or the EL wire 106 may vary depending on particular implementations.

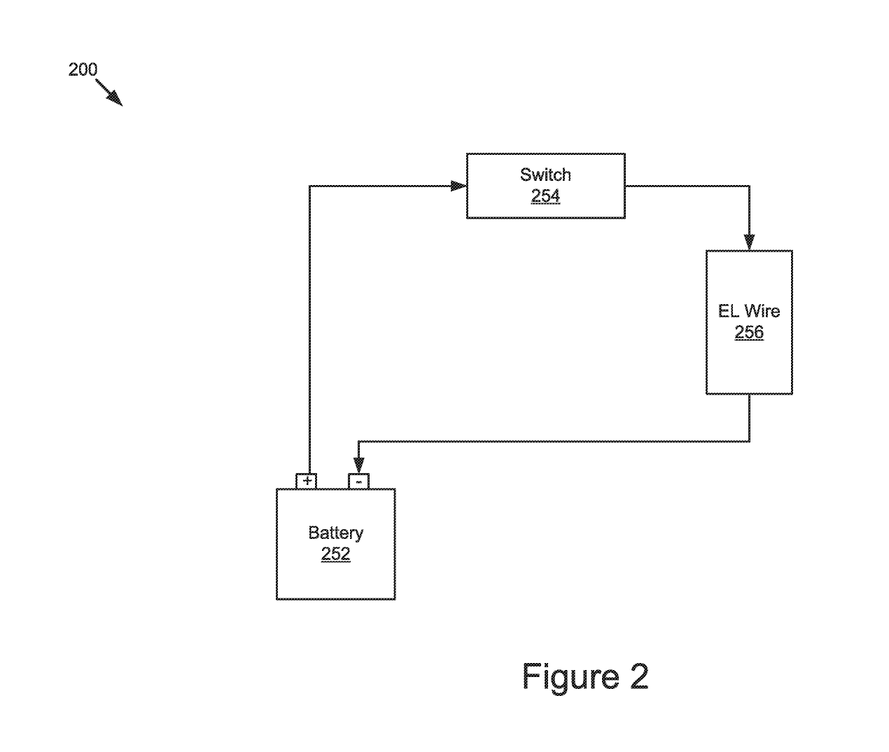

FIG. 2 is a block diagram that illustrates an example lighting system 200, arranged in accordance with at least some embodiments described herein. The lighting system 200 may be an example implementation of the lighting system 101 of FIG. 1. The lighting system 200 may include a battery 252 as a power supply source, a switch 254, an EL wire 256, and any other suitable elements. The battery 252 may be an example of the power supply 102 of FIG. 1. The switch 254 may be similar to or the same as the switch 104 of FIG. 1. The EL wire 256 may be similar to or the same as the EL wire 106 of FIG. 1. Similar description for the battery 252, the switch 254, and the EL wire 256 will not be repeated here.

The battery 252 may be electrically coupled to the switch 254, and the switch 254 may be electrically coupled to the EL wire 256. The EL wire 256 may also be electrically coupled to the battery 252. The switch 254 may be configured to control the power supply from the battery 252 to the EL wire 256 and to control an operation mode of the EL wire 256.

Modifications, additions, or omissions may be made to the lighting system 200 without departing from the scope of the present disclosure. For example, the lighting system 200 may include other elements or components not specifically described or mentioned.

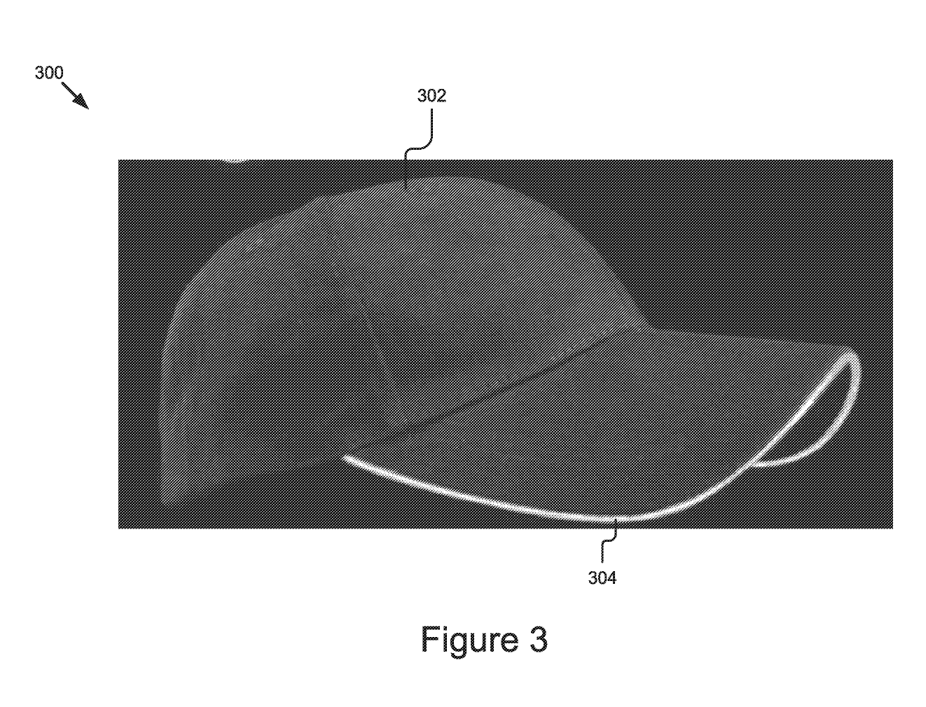

FIG. 3 is a graphic representation 300 that illustrates an example wearable article 302 with a lighting feature, arranged in accordance with at least some embodiments described in the present disclosure. In the present example, the wearable article 302 is depicted as a baseball cap. Although the wearable article 302 is illustrated as a baseball cap in FIG. 3, other types of wearable articles may also be implemented with the lighting feature. The wearable article 302 may include a lighting system configured to provide the lighting feature. The lighting system may include a power supply (not visible in FIG. 3), a switch (not visible in FIG. 3), an EL wire 304, and any other suitable elements. The lighting system of FIG. 3 may be similar to or the same as the lighting system 101 of FIG. 1 and/or the lighting system 200 of FIG. 2. As illustrated in FIG. 3, the EL wire 304 may be attached to an edge of a visor of the wearable article 302.

FIG. 4 is a graphic representation 400 that illustrates an example EL wire 412 attached to fabric pieces 410 of a wearable article, arranged in accordance with at least some embodiments described herein. The wearable article may include a lighting system (e.g., the lighting system 101 of FIG. 1 or the lighting system 200 of FIG. 2). The lighting system includes the EL wire 412 attached to the fabric pieces 410 of the wearable article.

The EL wire 412 may include a conductor 402, a light emitting phosphor 404, an insulator 408, and any other suitable elements. The conductor 402 may include any suitable conductor. For example, the conductor 402 may include a copper conductor in some embodiments. The conductor 402 may be configured to connect to a power supply (e.g., the power supply 102 or the battery 252) of a lighting system (e.g., the lighting system 101 or the lighting system 200). The light emitting phosphor 404 may contact the conductor 402. In some embodiments, the light emitting phosphor 404 may substantially enclose the conductor 402. The light emitting phosphor 404 may be configured to emit light in response to power provided to the conductor 402 by the power supply. The insulator 408 may be configured to enclose and protect the light emitting phosphor 404. In some embodiments, the insulator 408 may include a plastic insulator.

In some embodiments, the EL wire 412 may be attached to the wearable article through the insulator 408. For example, the insulator 408 may include a structure configured to attach the EL wire 412 to the wearable article. As illustrated in FIG. 4, the insulator 408 may include a tab 406 (e.g., a sew tab) that may be sandwiched between the fabric pieces 410 of the wearable article to attach the EL wire 412 to the wearable article.

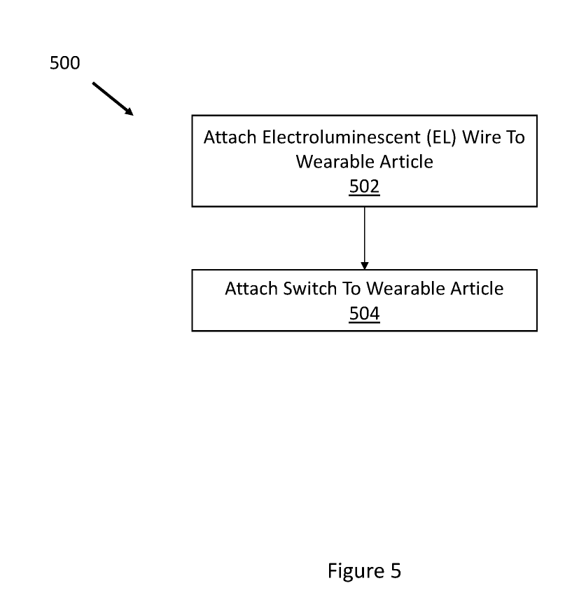

FIG. 5 is a flowchart of an example method 500 of producing a wearable article, according to one or more embodiments of the present disclosure. The method 500 may be performed using any suitable system, apparatus, or device. In some embodiments, the method 500 may be used to produce the wearable articles 105 and 302 described above.

The method 500 may begin at block 502 where an EL wire may be attached to a wearable article. For example, in some embodiments, the EL wire may be attached to an edge of a visor of a headwear article. In some embodiments, the EL wire may include a structure such as a tab and attaching the EL wire to the wearable article may include embedding the tab between fabric pieces of the wearable article. In particular, in some embodiments, the tab may be embedded between fabric pieces of the visor of the headwear article.

At block 504, a switch may be attached to the wearable article. For example, the switch may be attached to or integrated with the visor of a headwear article in some embodiments. The switch may be configured to control power supplied to a conductor of the EL wire such that the switch may control an operation mode of the EL wire.

Modifications, additions, or omissions may be made to the method 500 without departing from the scope of the present disclosure. For example, the operations of method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments. Additionally, the method 500 may include more operations than those described.

For example, in some embodiments, the method 500 may further include attaching a power supply to the wearable article such that the power supply is electrically coupled to the conductor and the switch. In these or other embodiments, the method 500 may include determining a configuration of the power supply based on a dimension (e.g., length, diameter, width, etc.) of the EL wire.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those w instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes which come within the meaning and range of equivalency of the claims are to be embraced within their scope.

What is claimed is:

1. A wearable article comprising:
a fabric piece;
an electroluminescent (EL) wire that includes:
a conductor;
a light emitting phosphor in contact with the conductor and configured to enclose the conductor and to emit light in response to the conductor receiving power; and
an insulator configured to enclose the light emitting phosphor, the insulator including a structure configured to attach to the fabric piece; and
a switch configured to control power supplied to the conductor such that the switch controls an operation mode of the EL wire.

2. The wearable article of claim 1, further comprising a power supply electrically coupled to the conductor and the switch and configured to supply power to the conductor as controlled by the switch.

3. The wearable article of claim 2, wherein the power supply includes a battery.

4. The wearable article of claim 2, wherein the power supply includes a configuration determined based on a dimension of the EL wire.

5. The wearable article of claim 1, wherein the switch is configured to turn on and off power from a power supply.

6. The wearable article of claim 1, wherein the operation mode of the EL wire includes one or more of the following: a continuous on mode, a flashing on and off mode, and a gradual on and off mode.

7. The wearable article of claim 1, wherein the structure includes a tab configured to be embedded between fabric pieces of the wearable article to attach the EL wire to the wearable article.

8. The wearable article of claim 1, wherein the conductor includes a copper conductor.

9. The wearable article of claim 1, wherein the wearable article includes a headwear article.

10. The wearable article of claim 9, wherein the EL wire is configured to be attached to an edge of a visor of the headwear article.

11. A method comprising:
attaching an electroluminescent (EL) wire to an edge of a visor of a headwear article, wherein the EL wire includes:
a conductor;
a light emitting phosphor in contact with the conductor and configured to enclose the conductor and to emit light in response to the conductor receiving power; and
an insulator configured to enclose the light emitting phosphor, the insulator including a structure configured to attach to the visor of the headwear article;
attaching a switch to the headwear article, wherein the switch is configured to control power supplied to the conductor such that the switch controls an operation mode of the EL wire.

12. The method of claim 11, further comprising attaching a power supply to the headwear article such that the power supply is electrically coupled to the conductor and the switch, wherein the power supply is configured to supply power to the conductor as controlled by the switch.

13. The method of claim 12, wherein the power supply includes a battery.

14. The method of claim 12, further comprising determining a configuration of the power supply based on a dimension of the EL wire.

15. The method of claim 11, wherein the operation mode of the EL wire includes one or more of the following: a continuous on mode, a flashing on and off mode, and a gradual on and off mode.

16. The method of claim 11 wherein the structure includes a tab and wherein attaching the EL wire to the edge of the visor includes embedding the tab between fabric pieces of the visor.

17. The method of claim 11, wherein the conductor includes a copper conductor.

18. The method of claim 11, wherein attaching the switch to the headwear article includes integrating the switch with a visor of the headwear article.
